(19) United States
(12) Patent Application Publication
(10) Pub. No.: US 2010/0141378 A1
(43) Pub. Date: Jun. 10, 2010

(54) APPARATUS AND METHOD FOR IDENTIFYING STRUCTURE

(75) Inventors: Kyong Hee LEE, Daejeon (KR); Hyun Kyun CHOI, Daejeon (KR); Jeong-Ho PARK, Daejeon (KR); Seung Yong LEE, Daejeon (KR); Inhak JOO, Daejeon (KR); Gwang Ja JIN, Daejeon (KR); Wan Sik CHOI, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/619,034

(22) Filed: Nov. 16, 2009

(30) Foreign Application Priority Data
Dec. 8, 2008 (KR) 10-2008-0124209
May 22, 2009 (KR) 10-2009-0045168

(51) Int. Cl. G05B 23/02

(52) U.S. Cl. 340/3.1

(57) ABSTRACT

A transmitter of an apparatus position in a moving body transmits a first move command signal for moving a radio frequency identification tag to a location within an identification distance to a receiver positioned within a communication distance. A radio frequency identification reader of the moving body transmits an information request signal to the radio frequency identification tag that moves from a first location to a second location corresponding to a location within an identification distance in accordance with a first move command signal and receives a response signal corresponding to the information request signal from the radio frequency identification tag.

### CROSS-REFERENCE TO RELATED APPLICATION

This application claims priority to and the benefit of Korean Patent Application No. 10-2008-0124209 and 10-2009-0045168 filed in the Korean Intellectual Property Office on Dec. 8, 2008 and May 22, 2009, the entire contents of which are incorporated herein by reference.

### BACKGROUND OF THE INVENTION

(a) Field of the Invention

The present invention relates to an apparatus and a method for identifying a structure. More particularly, the present invention relates to an apparatus and a method for identifying a structure using a radio frequency identification (RFID) tag.

(b) Description of the Related Art

A radio frequency identification tag (hereinafter referred to as ‘RFID tag’) can be divided into an active RFID tag that requires a power supply and a passive RFID tag that is actuated by an electro-magnetic field of a reader.

Since the passive RFID tag generates a voltage for actuating a chip included in the RFID tag by rectifying an alternating current (AC) signal received from an adjacent radio frequency identification reader (hereinafter referred to as ‘RFID reader’) into a direct current (DC) voltage, the passive RFID tag has an identification distance of the RFID reader that is shorter than that of the active RFID tag. Further, the passive RFID tag using a low frequency has an identification distance of the RFID reader that is merely several centimeters.

However, the passive RFID tag using a high frequency of an ultra-high frequency (UHF) band has an identification distance of the RFID reader that is longer than that of the passive RFID tag using the low frequency, and does not need to have a battery like the active RFID tag, such that the passive RFID tag using the high frequency is easy to maintain.

In the case of using the active RFID tag at the time of identifying a large-size structure such as a ship block by attaching the RFID tag to the large-size structure, since a radio wave fading phenomenon occurs due to reflection and refraction of a radio wave at a site where structures made of metals are stored, the RFID reader cannot normally identify the active RFID tag. Further, since the RFID reader has an identification distance of several tens to several hundreds of meters, the RFID reader has a disadvantage of identifying a plurality of active RFID tags at the same time.

Further, in the case of using the passive RFID tag, since the RFID reader has an identification distance of the passive RFID tag that is merely several meters, the RFID reader has a disadvantage of needing to be positioned close to the passive RFID tag.

However, in spite of the disadvantage of the passive RFID tag, work of turning the ship block in the air may need to be performed in order to identify the passive RFID tag attached to the ship block because the size and shape of the ship block are diverse even in the case of using the passive RFID tag. As a result, it is difficult to determine a location in the ship block at which the passive RFID tag will be attached.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for identifying a structure having advantages of efficiently managing a large-size structure made of metal.

An exemplary embodiment of the present invention provides a method for an apparatus to identify a radio frequency identification (RFID) tag attached to a structure. The RFID tag is movable by a connector which operates according to a control of a receiver of the apparatus positoned in the structure, wherinin the method includes: transmitting a first move command signal for moving the RFID tag to a location within an identification distance of the apparatus to the receiver in a case when the receiver is positioned between the identification distance and a communication distance of the apparatus which is longer than the identification distance; transmitting an information request signal to the RFID tag which has been moved from a first location to a second location corresponding to the location within the identification distance in accordance with the first move command signal; and receiving a response signal corresponding to the information request signal from the RFID tag.

Another embodiment of the present invention provides an apparatus for identifying a radio frequency identification (RFID) tag attached to a structure. The apparatus includes a transmitter for transmitting a move command signal for moving the RFID tag to a location within a predetermined identification distance; and a RFID reader for generating an information request signal, transmitting the same to the RFID tag, and receiving a response signal corresponding to the information request signal from the RFID tag, wherein the RFID tag is moved based on the move command signal.

Yet another embodiment of the present invention provides a radio frequency identification (RFID) tag device for communicating with an identifying apparatus including a RFID reader. The RFID tag device includes a RFID tag that stores management information on a structure to which the RFID tag is attached; a connector that moves the RFID tag from a first location to a second location; and a receivier that receives a move command signal from the identifying apparatus and activates the connector based on the move command signal to move the RFID tag.

Yet another embodiment of the present invention provides an apparatus for identifying a structure. The apparatus incldus a radio frequency identification (RFID) tag device that is position in the structure and includes a movable RFID tag; a transmitter that transmits a move command signal for moving the RFID tag a location within a predetermined identification distance and an information request signal; and a RFID reader that generates the information request signal and receives a response signal corresponding to the information request signal from the RFID tag.

### BRIEF DESCRIPTION OF THE DRAWINGS

FIG. 1 is a diagram illustrating a configuration of an apparatus for identifying a structure according to an exemplary embodiment of the present invention.

FIG. 2 is a diagram illustrating configurations of a transmitter and a receiver according to an exemplary embodiment of the present invention.

FIG. 3 is a diagram illustrating a method for identifying a structure according to an exemplary embodiment of the present invention.

FIG. 4 is a diagram illustrating shapes of a moving body and a structure according to an exemplary embodiment of the present invention.

FIG. 5 is a diagram illustrating a method for moving an RFID tag according to an exemplary embodiment of the present invention.

FIG. 6 is a diagram illustrating a method for identifying a tag according to an exemplary embodiment of the present invention.

FIG. 7 is a diagram illustrating a method for moving an RFID tag according to another embodiment of the present invention.

FIG. 8 is a diagram illustrating a method for identifying a plurality of structures according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, an apparatus and a method for identifying a structure according to an exemplary embodiment of the present invention will be described with reference to the accompanying drawings.

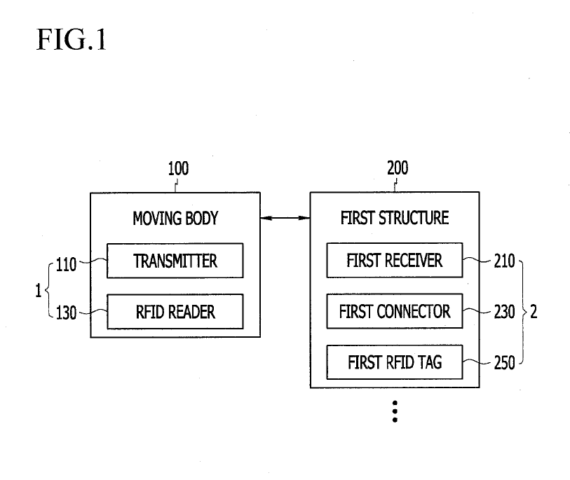

First, referring to FIG. 1, the apparatus for identifying a structure according to an exemplary embodiment of the present invention will be described.

FIG. 1 is a diagram illustrating a configuration of an apparatus for identifying a structure according to an exemplary embodiment of the present invention.

As shown in FIG. 1, the apparatus 1 for identifying a structure is located at a moving body 100 and identifies a plurality of structures.

The apparatus 1 for identifying a structure (hereinafter, it is called “an identifying apparatus”) includes a transmitter 110 and a radio frequency identification reader (hereinafter referred to as ‘RFID reader’) 130. The transmitter 110 or the RFID reader 130 may be attached to the exterior of the moving body 100.

The moving body 100 is movable in order to identify a plurality of structures in a wide space and may correspond to a carrier that carries the structures.

The transmitter 110 transmits a signal to a device corresponding to the transmitter 100 to allow the corresponding device to perform a predetermined function in accordance with the transmitted signal. The transmitter 110 can transmit a move command signal.

The RFID reader 130 identifies a radio frequency identification tag (hereinafter referred to as ‘RFID tag’) provided within a predetermined range, and collects management information of a structure attached with the corresponding RFID tag. The RFID reader 130 transmits an information request signal having a predetermined frequency to the corresponding RFID tag and receives a response signal corresponding to the transmitted signal to identify the corresponding RFID tag on the basis of the received response signal.

Meanwhile, the structure according to an embodiment of the present invention includes a RFID tag device 2 which communicates with the identifying apparatus 1.

The RFID tag device 2 will described as an example of a RFID tag device located on a first structure 200 corresponding to any one of the plurality of structures. The first structure 200 corresponding to any one of the plurality of structures, which are information collection targets of the RFID reader 130.

The RFID tag device located on a first structure 200 includes a first receiver 210, a first connector 230, and a first RFID tag 250.

The first receiver 210, which corresponds to the transmitter 110, controls the first connector 230 so that the first RFID tag 250 moves in accordance with a move command signal received from the transmitter 110 of the identifying apparatus.

The first connector 230 physically connects the first receiver 210 and the first RFID tag 250 to each other and moves the first RFID tag 250 in a predetermined direction in accordance with control of the first receiver (210). At this time, the first connector 230 can limit a movement range of the first RFID tag 250. Further, the first connector 230 can move the first RFID tag 250 upward and downward using such as a spring.

The first RFID tag 250, which is connected to the first connector 230, stores management information of the first structure 200 and transmits a response signal including the management information of the first structure 200 to the RFID reader 130 on the basis of an information request signal having a predetermined frequency, which is received from the RFID reader 130 that is provided within a predetermined range. The first RFID tag 250 corresponds to a passive RFID tag.

A communicable distance between the transmitter 110 and the first receiver 210 is longer than an identification distance of the first RFID tag 250 that the RFID reader 130 can identify.

The RFID tag device as described above may be respectively positioned in structures which are information collection targets of the RFID reader 130.

The identifying apparatus 1 identifies a structure by communicating with the RFID tag device, but may be realized in a form of including the RFID tag device. That is, the identifying apparatus may be embodied in a form of including a transmitter and a RFID reader which are position in a moving body, and a RFID tag device including a receiver, connector, and a RFID tag which are poisoned in a structure.

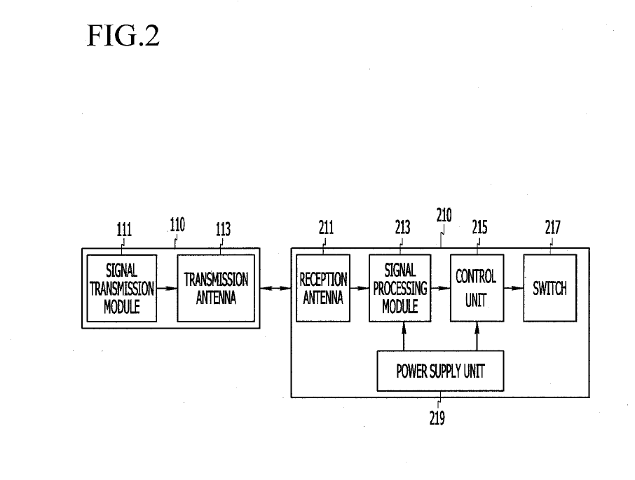

Next, referring to FIG. 2, configurations of a transmitter and a receiver according to an exemplary embodiment of the present invention will be described.

FIG. 2 is a diagram illustrating configurations of a transmitter and a receiver according to an exemplary embodiment of the present invention.

As shown in FIG. 2, the transmitter 110 includes a signal transmission module 111 and a transmission antenna 113, and the receiver 210 includes a reception antenna 211, a signal processing module 213, a control unit 215, a switch 217, and a power supply unit 219.

The signal transmission module 111 generates a move command signal including a tag move command for moving the RFID tag. The transmission antenna 113 transmits the move command signal to the receiver 210.

The reception antenna 211 receives the move command signal from the transmitter 110. The signal processing module 213 detects the tag move command from the received move command signal.

The control unit 215 controls the switch 217 so that the first connector 230 moves the first RFID tag 250 in a predetermined direction in accordance with the tag move command. The switch 217 controls the first connector 230 in accordance with the control unit 215.

For example, the first connector 239 may be a spiral spring. In this case, the first RFID tag 250 is connected to one end of the spiral spring and another of the spiral spring is connected to the switch 217. When current by the operation of the switch 217 is applied to the spiral spring, the spiral spring extends against a direction to which elastic force applies and then the first RFID tag moves from a first location to a second location. Accordingly, a communication between the first RFID 250 and the RFID reader 130 may be performed. Then, the first RFID tag 250 is returned to the second location due to restoring force of the spiral spring.

Further, the RFID tag can be moved by a motor. For example, the first connector 239 includes a motor and a string to which the first RFID tag 250 is connected. As described above, based on a signal output from the switch 217 according to the move command signal, the motor moves so that the first RFID tag 250 connected to the string moves. That is, the first RFID tag 250 moves from the first location to the second location, thereby communicating with the RFID reader 130. After this, the motor returns to an original location according to a signal provided through the switch 217 from the control unit 215, and therefore, the first RFID tag 250 moves from the second location to the first location. Moving a RFID tag with a motor may accurately control the movement and stop of the RFID tag in comparison to using a spiral spring. For example, it is possible to position the RFID tag at the second location until a communication with the RFID reader 130 is performed and then to return the RFID tag to the first location after the communication.

The first connector 230 is not restricted to including the motor and the spring and may be embodied with means provided by those skilled in the art as described in the exemplary embodiments. Meanwhile, the switch 217 may be not used as the case may be. For example, a signal from the control unit 215 may be directly to the motor.

Theses examples may be applied to connectors of RFID tag devices according to embodiments of the present invention without being restricted to the first connector.

The power supply unit 219 supplies electric power to the signal processing module 213 and the control unit 215. The power supply unit 219 can supply the electric power by using solar energy.

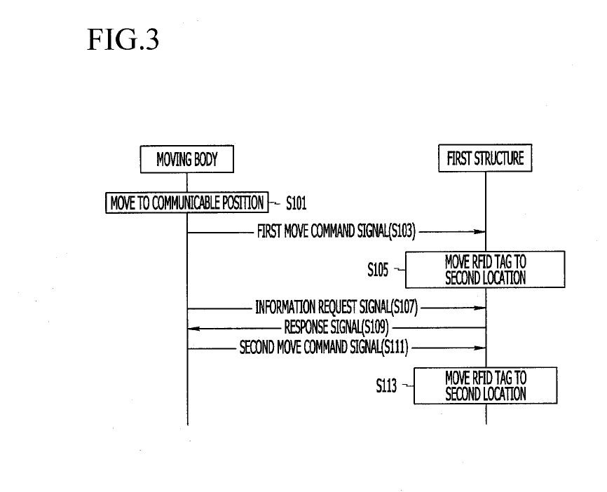

Next, referring to FIGS. 3 to 7, a method in which an identifying apparatus identifies a structure according to an exemplary embodiment of the present invention will be described.

FIG. 3 is a diagram illustrating a method for identifying a structure according to an exemplary embodiment of the present invention.

As shown in FIG. 3, first, the moving body 100 moves to a communicable position with respect to a first structure 200. At this time, the moving body 100 moves to a communicable position between a transmitter 110 and a first receiver 210 depending on a communicable distance between the transmitter 110 and the first receiver 210 of the first structure 200.

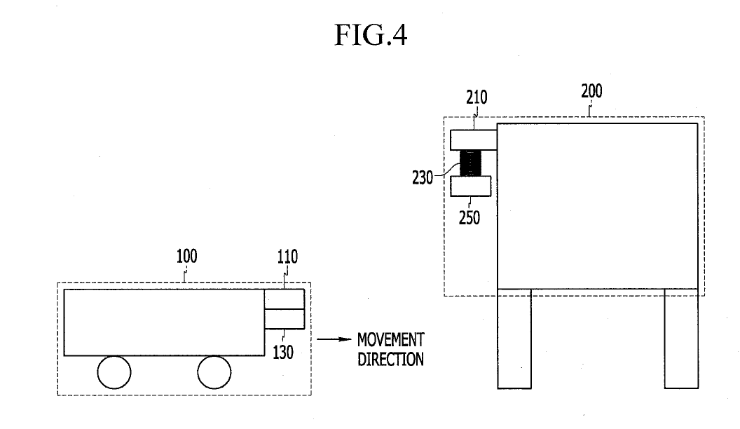

Hereinafter, referring to FIG. 4, shapes of the moving body 100 and the first structure 200 will be described.

FIG. 4 is a diagram illustrating shapes of a moving body and a structure according to an exemplary embodiment of the present invention.

As shown in FIG. 4, the transmitter 110 and the RFID reader 130 of the identifying apparatus are attached to the exterior of the moving body 100. Further, the first receiver 210, the first connector 230, and the first RFID tag 250 of the first structure 200 are attached to the exterior of the first structure 200.

The first RFID tag 250 of the first structure 200 is connected to the bottom of the first connector 230 and positioned at a first location.

The moving body 100 moves in a movement direction so as to move to a communicable position.

After the moving body 100 is positioned at the communicable position, as shown in FIG. 3, the transmitter 110 of the identifying apparatus positioned in the moving body 100 transmits a first move command signal to the first receiver 210 of the first structure 200 in order to move the first RFID tag 250 within the identification distance of the RFID reader 130 (S130).

Thereafter, the first connector 230 of the first structure 200 moves the first RFID tag 250 from a first location to a second location by the control of the first receiver 210 (S105).

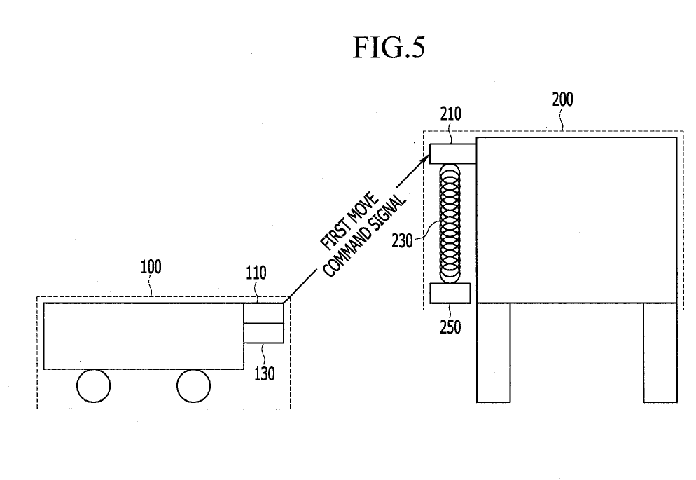

Hereinafter, referring to FIG. 5, a method for moving a first RFID tag from the first location to the second location according to an exemplary embodiment of the present invention will be described.

FIG. 5 is a diagram illustrating a method for moving an RFID tag according to an exemplary embodiment of the present invention.

As shown in FIG. 5, the first receiver 210 detects a tag move command from the first move command signal from the first receiver 210 and controls a switch 217 in accordance with the detected tag move command.

The first connector 230 moves the first RFID tag 250 from the first location to the second location by moving the first RFID tag 250 connected to the bottom of the first connector 230 downward by controlling the switch 217. Therefore, the first RFID tag 250 can be positioned within the identification distance of the RFID reader 130.

As described above, when the first RFID tag 250 is positioned within the identification distance of the RFID reader 130, the RFID reader 130 of the identifying apparatus transmits an alternating current signal to the first RFID tag 250 that is positioned at the second location (S107). That is, the RFID reader 130 transmits an information request signal to the first RFID tag 250 in order to activate the first RFID tag 250 that corresponds to a passive RFID tag.

Thereafter, the first RFID tag 250 of the first structure 200 transmits the response signal including the management information of the first structure 200 to the RFID reader 130 on the basis of the received information request signal (S109). The first RFID tag 250 generates a direct current voltage by rectifying the received information request signal to transmit the response signal by using the direct current voltage.

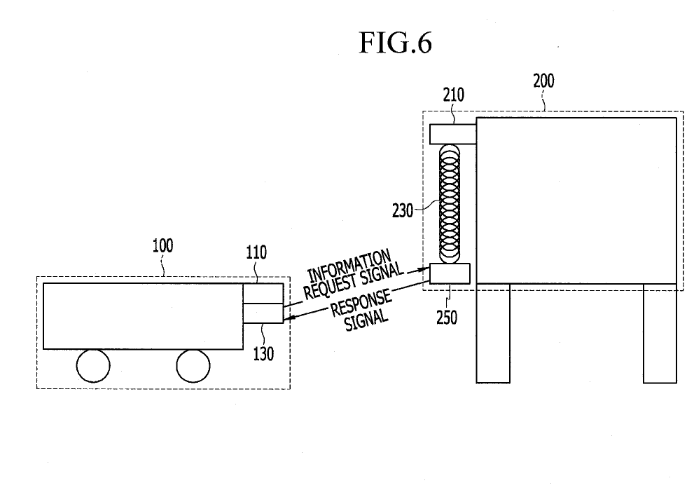

Hereinafter, referring FIG. 6, the method in which an RFID reader identifies an RFID tag according to an exemplary embodiment of the present invention will be described.

FIG. 6 is a diagram illustrating a method for identifying a tag according to an exemplary embodiment of the present invention.

As shown in FIG. 6, first, the RFID reader 130 activates the first RFID tag 250 by transmitting the alternating current signal of the information request signal to the first RFID tag 250 positioned at the second location corresponding to a location within a predetermined identification distance of the RFID reader 130.

Next, the first RFID tag 250 generates the direct current voltage by rectifying the received alternating current signal and transmits the response signal including the management information of the first structure 200 on the basis of the generated direct current voltage.

Therefore, the RFID reader 130 can acquire the management information of the first structure 200 by identifying the first RFID tag 250.

After the RFID reader 130 acquires the management information of the first structure 200, as shown in FIG. 3, the transmitter 110 of the moving body 100 transmits a second move command signal for moving the first RFID tag 250 back to the first location to the first receiver 210 of the first structure 200 (S111).

Thereafter, the first connector 230 of the first structure 200 moves the first RFID tag 250 from the second location to the first location by the control of the first receiver 210 (S113).

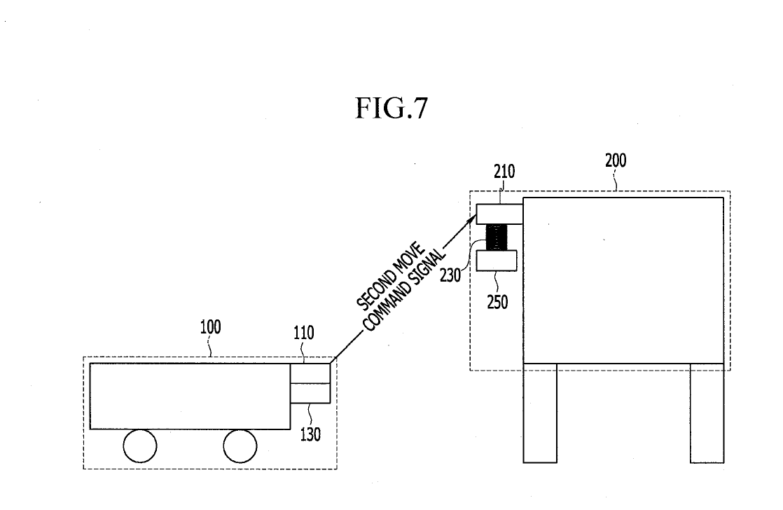

Hereinafter, referring to FIG. 7, a method for moving a first RFID tag from a second location to a first location according to an exemplary embodiment of the present invention will be described.

FIG. 7 is a diagram illustrating a method for moving an RFID tag according to another embodiment of the present invention.

As shown in FIG. 7, the first receiver 210 detects the tag move command from the received second move command signal and controls the switch 217 in accordance with the detected tag move command.

The first connector 230 moves the first RFID tag 250 from the second location to the first location again by moving the first RFID tag 250 connected to the bottom of the first connector 230 upward, by controlling the switch 217.

At this time, since the first RFID tag 250 is deviated from the identification distance of the RFID reader 130, the RFID reader 130 cannot identify the first RFID tag 250 positioned at the first location.

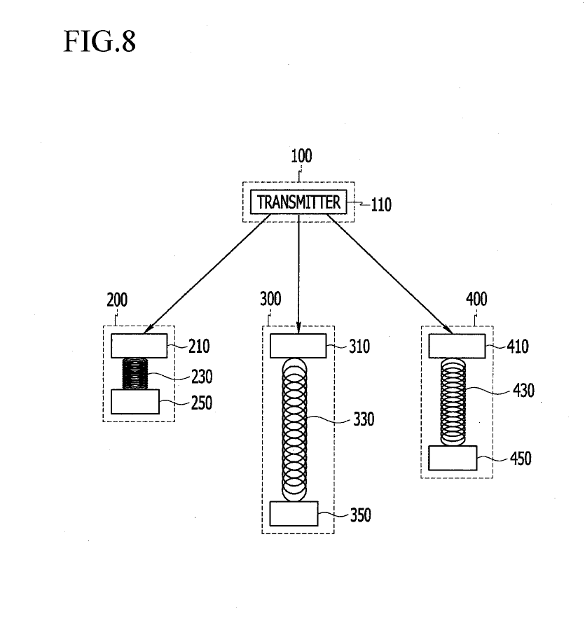

Next, referring to FIG. 8, a method in which a moving body identifies a plurality of structures according to an exemplary embodiment of the present invention will be described.

FIG. 8 is a diagram illustrating a method for identifying a plurality of structures according to an exemplary embodiment of the present invention.

As shown in FIG. 8, the plurality of structures such as the first structure 200, a second structure 300, and a third structure 400 are positioned in the vicinity of the moving body 100. The first structure 200 includes the first receiver 210, the first connector 230, and the first RFID tag 250, the second structure 300 includes a second receiver 310, a second connector 330, and a second RFID tag 350, and the third structure 400 includes a third receiver 410, a third connector 430, and a third RFID tag 450.

At this time, each of the first receiver 210, the second receiver 310, and the third receiver 410 is positioned at a location communicable with the transmitter 110.

In this case, the transmitter 110 of the moving body 100 does not transmit the move command signal to the plurality of receivers at the same time, but transmits the move command signal to the second receiver 310, the third receiver 410, and the first receiver 210 in sequence.

Therefore, the moving body 100 can select a target object from the plurality of structures by identifying the RFID tags in the order of the second RFID tag 350, the third RFID tag 450, and the first RFID tag 250.

According to an embodiment of the present invention, by moving an RFID tag that has deviated from an identification distance of an RFID reader within the identification distance to identify the RFID tag, the identification distance of the RFID reader can be extended and large-size structures having irregular sizes and shapes can be effectively managed.

The embodiments of the present invention are implemented not only through the apparatus and method, but may be implemented through a program that realizes functions corresponding to constituent members of the exemplary embodiments of the present invention or a recording medium in which the program is recorded. The invention can be easily implemented by those skilled in the art as described in the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for an apparatus to identify a radio frequency identification (RFID) tag attached to a structure,
wherein the RFID tag is movable by a connector which operates according to a control of a receiver of the apparatus positoned in the structure,
the method includes:
transmitting a first move command signal for moving the RFID tag to a location within an identification distance of the apparatus to the receiver in a case when the receiver is positioned between the identification distance and a communication distance of the apparatus which is longer than the identification distance;
transmitting an information request signal to the RFID tag which has been moved from a first location to a second location corresponding to the location within the identification distance in accordance with the first move command signal; and
receiving a response signal corresponding to the information request signal from the RFID tag.

2. The method for identifying a structure of claim 1, wherein
the response signal includes management information of the structure.

3. The method for identifying a structure of claim 1, further comprising:
transmitting a second move command signal for moving the RFID tag from the second location to the first location after receiving the response signal.

4. The method for identifying a structure of claim 1, further comprising:
moving a moving body at which the apparatus is positioned to a communicable position between the transmitter and the receiver in a case when the receiver is positioned at a location that is deviated from the communication distance.

5. An apparatus for identifying a radio frequency identification (RFID) tag attached to a structure, comprising:
a transmitter for transmitting a move command signal for moving the RFID tag to a location within a predetermined identification distance; and
a RFID reader for generating an information request signal, transmitting the same to the RFID tag, and receiving a response signal corresponding to the information request signal from the RFID tag,
wherein the RFID tag is moved based on the move command signal.

6. The apparatus of claim 5, wherein
the transmitter includes:
a signal transmission module that generates a move command signal including a move command for moving the RFID tage from the a location to a second location and another move command signal including a move command for moving the RFID tage from the second location to the first location; and
a transmission antenna for transmitting the move command signal.

7. The apparatus of claim 5, wherein a communication distance of the transmitter is longer than an identification distance of the RFID reader.

8. A radio frequency identification (RFID) tag device for communicating with an identifying apparatus including a RFID reader, comprising:
a RFID tag that stores management information on a structure to which the RFID tag is attached;
a connector that moves the RFID tag from a first location to a second location; and
a receivier that receives a move command signal from the identifying apparatus and activates the connector based on the move command signal to move the RFID tag.

9. The RFID tag device of claim 8, wherein the RFID tag generates a response signal including the management information on the structure according an information request signal transmitted from the RFID reader of the identifying apparatus and transmits the response signal to the RFID reader.

10. The RFID tag device of claim 8, wherein
the receiver includes
a reception antenna that receives the move command signal;
a signal processing module that detects the move command from the move command signal;
a control unit that generates control signal for movement of the RFID tag from the first location to the second location and movement of the RFID tag from the second location to the first location; and
a switch that activates the connector in accordance with the control signals.

11. An apparatus for identifying a structure, comprising:
a radio frequency identification (RFID) tag device that is position in the structure and includes a movable RFID tag;
a transmitter that transmits a move command signal for moving the RFID tag a location within a predetermined identification distance and an information request signal; and
a RFID reader that generates the information request signal and receives a response signal corresponding to the information request signal from the RFID tag.

12. The apparatus for identifying a structure of claim 11, wherein the RFID tag device includes management information in the response signal and transmits the response signal.

13. The apparatus for identifying a structure of claim 11, wherein
the RFID tag device includes
a connector that moves the RFID tag from a first location to a second location; and
a receiver that receives the move command signal from the transmitter and activates the connector according to the move command signal.

14. The apparatus for identifying a structure of claim 11, wherein
a communication distance of the transmitter is loger than an identification distance of the RFID reader, and
the transmitter transmits the move command signal when the RFID tag is positioned between the communication distance and the identification distance.
